(19) United States
(12) Patent Application Publication
(10) Pub. No.: US 2017/0359130 A1
(43) Pub. Date: Dec. 14, 2017

(54) Prevention of Crosstalk During Single-Ended Line Testing

(71) Applicant: Metanoia Communications Inc., Hsinchu (TW)

(72) Inventor: Chun-Che Chang, Hsinchu (TW)

(21) Appl. No.: 15/620,847

(22) Filed: Jun. 13, 2017

Related U.S. Application Data
(60) Provisional application No. 62/349,641, filed on Jun. 13, 2016.

(51) Int. Cl. H04B 17/30; H04L 5/00; H04L 5/14

(52) U.S. Cl. CPC H04B 17/30; H04L 5/14; H04L 5/0007

(57) ABSTRACT

Examples pertaining to prevention of crosstalk during single-ended line testing are described. In a far-end crosstalk (FEXT) cancelled single-point-to-multi-point time-division duplexing (TDD) orthogonal frequency-division multiplexing (OFDM) communication system, a first communication device may signal a plurality of second communication devices that there is a quiet period where one port of multiple ports of the first communication device will transmit zero energy on a plurality of communications channels between the first communication device and the second communication devices. The first communication device may transmit a stimulus on a selected port during the quiet period. The first communication device may derive loop parameters from an echo response of the stimulus. The first communication device may be communicatively coupled to the plurality of second communication devices, with each of at least some of the multiple ports of the first communication device is connected to a respective one of the second devices through a crosstalk affected channel of the plurality of communication channels.

### CROSS REFERENCE TO RELATED PATENT APPLICATION

The present disclosure claims the priority benefit of U.S. Patent Application No. 62/349,641, filed 13 Jun. 2016, the content of which is incorporated by reference in its entirety.

### TECHNICAL FIELD

The present disclosure generally relates to the field of digital communication and, more particularly, to the management of crosstalk in orthogonal frequency-division multiplexing (OFDM)-based communication systems.

### BACKGROUND

ITU-T G.fast, or G.9701, describes a time-division multiplexing (TDM) orthogonal-frequency division modulation (OFDM) point-to-multi-point communication system where a multi-port communication device, herein referred to as FTU-O, is connected to multiple communications devices, herein referred to as FTU-Rs. The communication channel can be copper phone lines such as twisted-pair or coaxial cables. The place that an FTU-O is located is commonly called as a drop point (DP). The communication channels are usually mutually coupled by strong crosstalk and, hence, under normal operation a far-end crosstalk (FEXT) cancellation technique, also known as vectoring, is used by G.fast. In vectoring, a precoder controlled by a vectoring control entity (VCE) is situated in a FTU-O to pre-compensate a signal leaving the FTU-O in the downstream direction in such a way that the signal received at the FTU-Rs are crosstalk free. In G.9701 terminologies a training state means the transceiver is adapting to the channel through transmitting or receiving a series of predefined signals while a showtime state means a stable state where user payload data is sent or received by the transceiver.

On the other hand, single-ended line testing (SELT) is a technique for identifying loop parameters such as loop length, termination, number of bridge taps and the location of bridge taps. Traditionally, as defined in ITU-T G.996.2 (G.It), SELT is a functionality that is separated from various standards such as ITU-T G.992.3 (ADSL2), ITU-T G.993.2 (VDSL2) and ITU-T G.993.5 (VDSL2 with FEXT cancellation). If SELT is to be performed for a specific loop, that loop should be disconnected and stay in a disabled state (L3) before SELT can be launched. This approach in general is not a problem for ADSL2 and VDSL2 frequencies spectrum that is below 17 MHz. However, with the 106 MHz spectrum of G.fast performing SELT on a single line, excessive crosstalk may be introduced to an adjacent line in the same bundle.

### SUMMARY

Various embodiments of schemes, mechanisms, systems, methods, techniques and devices that prevent excessive crosstalk from being introduced to an adjacent line when SELT is performed on a single line in the same bundle of lines.

In a far-end crosstalk (FEXT) cancelled single-point-to-multi-point time-division duplexing (TDD) orthogonal frequency-division multiplexing (OFDM) communication system, a first communication device may signal a plurality of second communication devices that there is a quiet period where one port of a plurality of communication ports of the first communication device will transmit zero energy on a plurality of communications channels between the first communication device and the second communication devices. The first communication device may transmit a stimulus on a selected port of the plurality of communication ports during the quiet period. The first communication device may derive loop parameters from an echo response of the stimulus. The first communication device may be communicatively coupled to the plurality of second communication devices, with each of at least some of the plurality of communication ports of the first communication device connected to a respective one of the second devices through a crosstalk affected channel of the plurality of communication channels.

In some embodiments, the loop parameters may include a loop length, wire gauges, a termination indication, a number of bridge taps, a location of bridge taps, a signal-to-noise ratio (SNR), and a channel capacity.

In some embodiments, the communication system may include a ITU-T G.9701 system

In some embodiments, the quiet period may be located in a SYNC symbol position or in a discontinuous operation interval (DOI).

This summary is provided to introduce concepts relating to crosstalk avoidance. Some embodiments of the schemes, mechanism, techniques, methods, systems and devices are further described below in the detailed description. This summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure.

FIG. 1 illustrates an example scenario in accordance with an embodiment of the present disclosure.

FIG. 2 is a diagram showing power spectral density of echo of SELT versus near-end crosstalk (NEXT) in accordance with the present disclosure.

FIG. 3 is a diagram showing a coupling path from SELT port to other showtime ports in accordance with the present disclosure.

FIG. 4 is a diagram of an example setup for transmitting SELT stimulus in SYNC system position in accordance with the present disclosure.

FIG. 5 is a diagram of an example setup for transmitting SELT stimulus in discontinuous operation interval (DOI) in accordance with the present disclosure.

FIG. 6 is a block diagram of an example apparatus in accordance with an implementation of the present disclosure.

FIG. 7 is a flowchart of an example process in accordance with an implementation of the present disclosure.

### DETAILED DESCRIPTION OF PREFERRED EMBODIMENTS

### Overview

SELT relies on echo which is a signal that is originated from one side of a loop and bounced back, as a bounce-back signal, after it hits the discontinuity at the far-end. The bounce-back signal is then examined by the receiver, and loop parameters may be derived from the bounce-back signal. Two types of stimulus are commonly used for SELT, namely: time domain reflectometry (TDR) and frequency domain reflectometry (FDR). A typical report for SELT results contains the following items: (1) uncalibrated echo response, (2) quiet line noise, (3) loop termination indicator (open/short/powered on CPE/unknown), (4) loop length, and (5) loop topology (number and location of bridge taps).

The G.fast system is a time-division duplexing (TDD) system where upstream transmissions and downstream transmissions are separated into non-overlapping time slots. Near-end crosstalk (NEXT) has no influence on the performance because all transmitters at the FTU-O transmit simultaneously. However, NEXT can be a problem if SELT is to be performed in one line in a vectored-group.

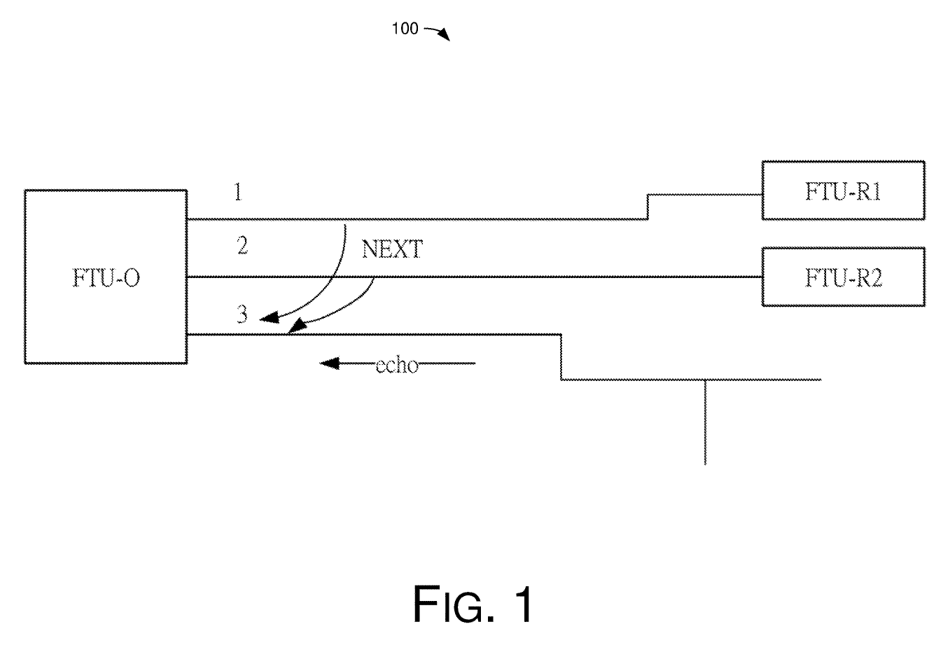

FIG. 1 illustrates an example with multiple loops including loop 1, loop 2 and loop 3. In this example, loop 1 and loop 2 are in showtime and FTU-O performs SELT on loop 3. The echo signal in loop 3 will be affected by the NEXT signal from loop 1 and loop 2.

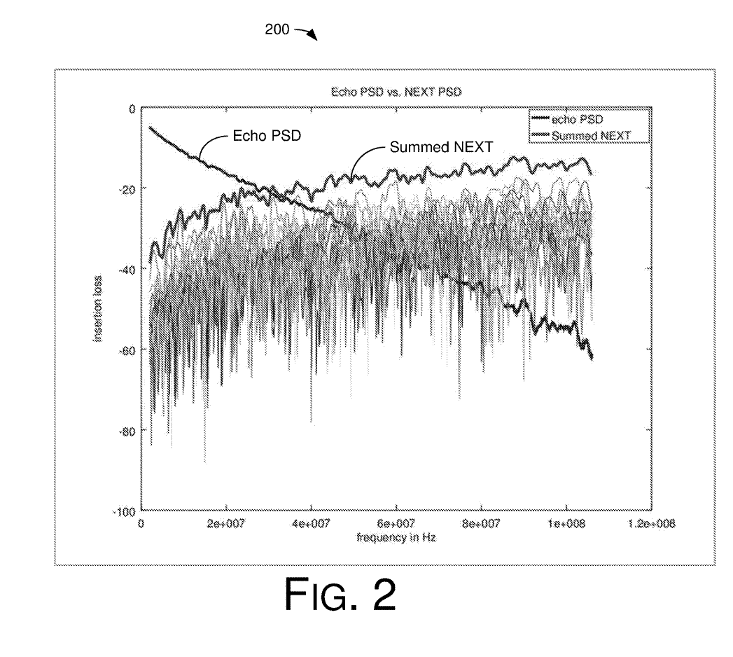

Using measurements of twenty pairs of 100-meter equal-length cable bundle by British Telecom, assuming the SELT stimulus is transmitted with the same power spectral density (PSD) as the normal data symbols, FIG. 2 shows the echo PSD for port 1 and the NEXT PSD from other ports. The echo PSD is generated by summing the insertion loss twice to account for the round-trip.

It can be seen in FIG. 2 that NEXT dominates the receive power in frequency regions above 40 MHz. The more ports that are in showtime the higher the NEXT noise floor is. This poses a problem for SELT to retrieve information from high frequencies.

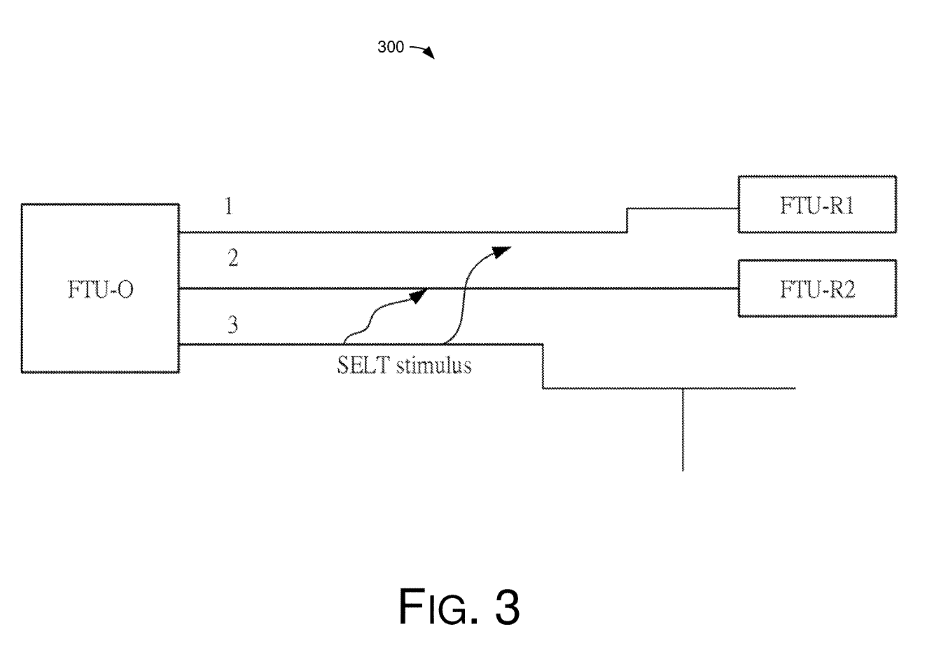

As shown in FIG. 2, in the opposite direction, SELT stimulus might introduce noise to other lines in a vectored group. The SELT stimulus is not precoded and does not necessary align to the symbol boundary and, hence, SELT stimulus might contribute noise to other lines as depicted in FIG. 3. The un-cancelled FEXT might result in errors at the far-end. The impact from SELT on the vectored-group can be lowered by transmitting the stimulus at a lower level but the drawback is obvious, as the echo power is also lowered.

### Proposed Scheme

In order to eliminate the interferences between SELT and other loops in the same vectored-group, it is essential to find a time slot in the downstream transmission opportunity that all transmitters remain quiet at the U interface. There are two possible time slots, namely: the SYNC symbol position and non-overlapped discontinuous operation interval (DOI).

In the current G.fast standard, the SYNC symbol carries three types of signals from the set {−1, 0, 1}. The SYNC symbol can be either precoded or non-precoded. These properties make the position of the SYNC symbol a candidate for transmitting the SELT stimulus. If SELT is to be performed on a specific line, the VCE configures all lines to transmit 0 in the SYNC symbol position non-precoded, and to overlay the SELT stimulus on the SYNC symbol position of the SELT line. According to the current G.fast standard, only synchronization symbol modulated by {1, −1} is allowed as stimulus. If this constraint is relaxed then almost all arbitrary signals may be used as the stimulus such as a filtered impulse signal without affecting the whole system. This allows both the frequency domain reflectometry (FDR) approach and the time domain reflectometry (TDR) approach for the SELT algorithm.

One drawback of using SYNC symbol is the duration of stimulus transmission is limited to about 23 micro-second, which is the duration of one symbol. It might be acceptable for TDR, associated with impulsive signals, but might not work for FDR for longer lines with longer echo responses.

Another possible place to transmit the SELT stimulus is the DOI time slots. The VCE can configure the loops in a vectored group by manipulating TA and B parameters as defined in ITU-T G.9701 such that there is a quiet period for all lines. This period can be for plural symbols and can allow more time for the echo to propagate. Another benefit associated with using the DOI for SELT is that doing so allows the port that is already in showtime to perform SELT. By allocating plural symbol periods for SELT, the SELT port can adjust its receiver's programmed gain amplifier (PGA) to optimize the dynamic range before and after SELT stimulus is transmitted.

In sum, sending the SELT stimulus in either SYNC symbol position(s) or DOI time slot(s) would achieve the goal. Between the two approaches, using DOI time slot would allow more flexibility.

### Example Implementations

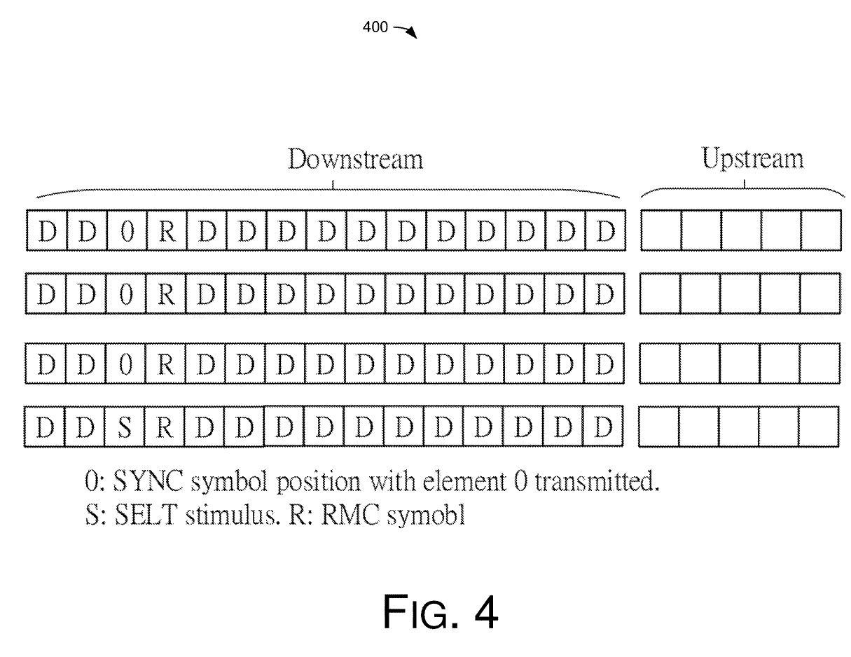

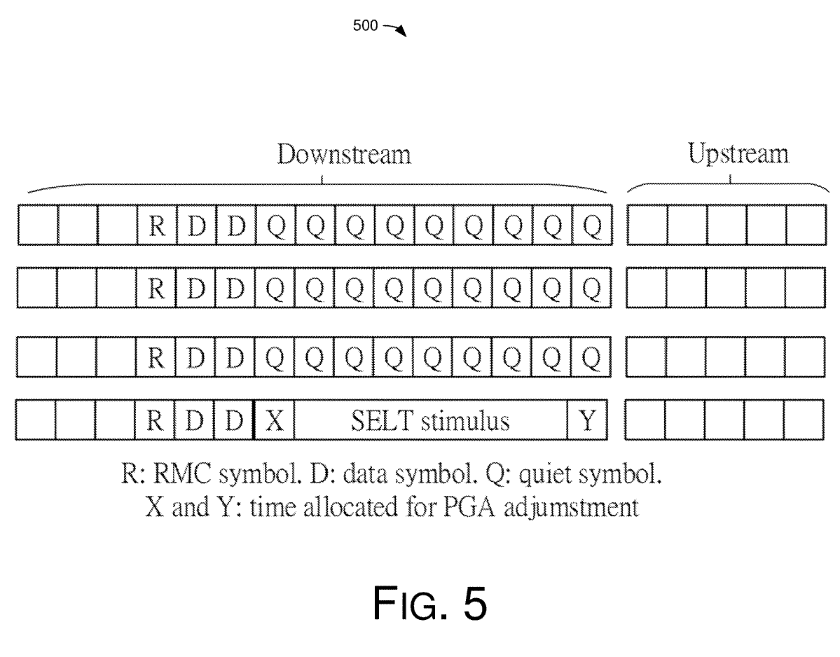

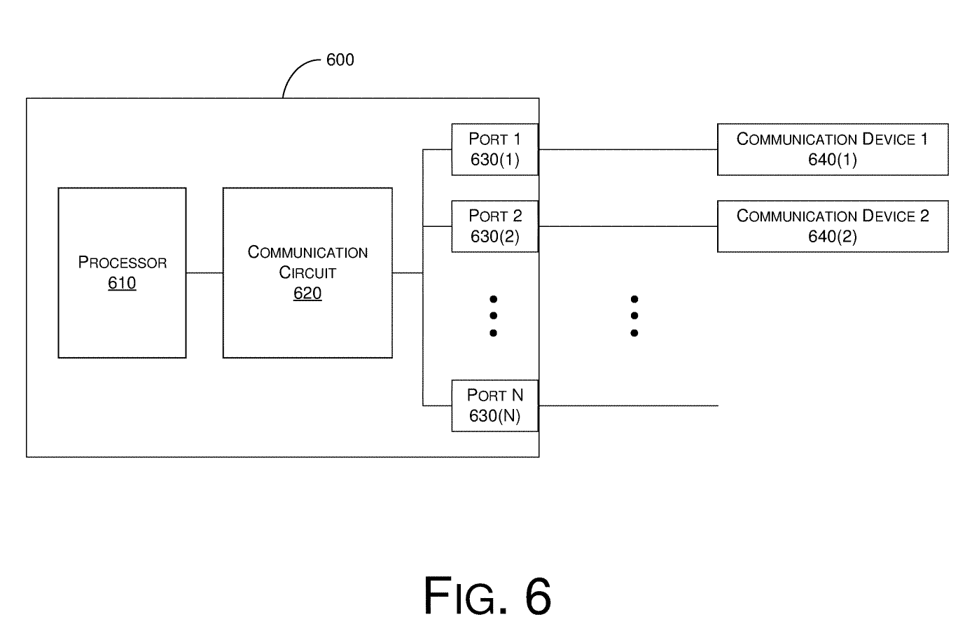

FIG. 6 illustrates an example apparatus 600 in accordance with an implementation of the present disclosure. Apparatus 600 may be an example implementation of FTU-O in FIG. 1 and FIG. 3. Apparatus 600 may perform various functions, operations and/or tasks to implement concepts, schemes, techniques, processes and methods described herein pertaining to management of crosstalk in OFDM-based communication systems, such as prevention of crosstalk during SELT in accordance with the present disclosure, including those described with respect to some or all of FIG. 1-FIG. 5 as well as process 700 described below.

Apparatus 600 may be a part of an electronic apparatus or a transportation vehicle such as an automobile. For instance, apparatus 600 may be implemented in a router, gateway, switch, base station and the like. Alternatively, apparatus 600 may be implemented, at least partly, in the form of one or more integrated-circuit (IC) chips such as, for example and not limited to, one or more single-core processors, one or more multi-core processors, or one or more complex-instruction-set-computing (CISC) processors.

Apparatus 600 may include at least some of those components shown in FIG. 6. For instance, apparatus 600 may include at least a processor 610. Additionally, apparatus 600 may include a communication circuit 620 and plurality of communication ports such as communication ports 630(1)-630(N) (shown as “port 1”, “port 2” . . . and “port N” in FIG. 6), where N is a positive integer. Processor 610 may control communication circuit 620 to transmit and receive signals through communication ports 630(1)-630(N).

In one aspect, processor 610 may be implemented in the form of one or more single-core processors, one or more multi-core processors, or one or more CISC processors. That is, even though a singular term “a processor” is used herein to refer to processor 610, processor 610 may include multiple processors in some embodiments and a single processor in other embodiments in accordance with the present disclosure. In another aspect, processor 610 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some embodiments, processor 610 is a special-purpose machine specifically designed, arranged and configured to perform specific tasks including prevention of crosstalk during SELT in accordance with various implementations of the present disclosure.

In some embodiments, processor 610 may signal, via communication circuit 620 and through at least some of communication ports 630(1)-630(N) (e.g., communication ports 630(1) and 630(2)), a plurality of second communication devices (e.g., communication devices 640(1) and 640(2)) that there is a quiet period where one port of the plurality of communication ports 630(1)-630(N) will transmit zero energy on a plurality of communications channels between communication circuit 620 and the second communication devices. Processor 610 may also transmit, via communication circuit 620, a stimulus on a selected port of communication ports 630(1)-630(N) during the quiet period. Processor 610 may further derive, via communication circuit 620, loop parameters from an echo response of the stimulus. The at least some of the plurality of communication ports 630(1)-630(N) (e.g., communication ports 630(1) and 630(2)) may be communicatively coupled to the second communication devices (e.g., communication devices 640(1) and 640(2)). Each of at least some of the communication ports 630(1)-630(N) of apparatus 600 may be connected to a respective one of the second devices through a crosstalk affected channel of the plurality of communication channels. The plurality of second communication devices (e.g., communication devices 640(1) and 640(2)) may be part of a far-end crosstalk (FEXT) cancelled single-point-to-multi-point TDD OFDM communication system.

In some embodiments, the loop parameters may include a loop length, wire gauges, a termination indication, a number of bridge taps, a location of bridge taps, a signal-to-noise ratio (SNR), and a channel capacity.

In some embodiments, the communication system may include a ITU-T G.9701 system

In some embodiments, the quiet period may be located in a SYNC symbol position. Alternatively, the quiet period may be located in a discontinuous operation interval (DOI).

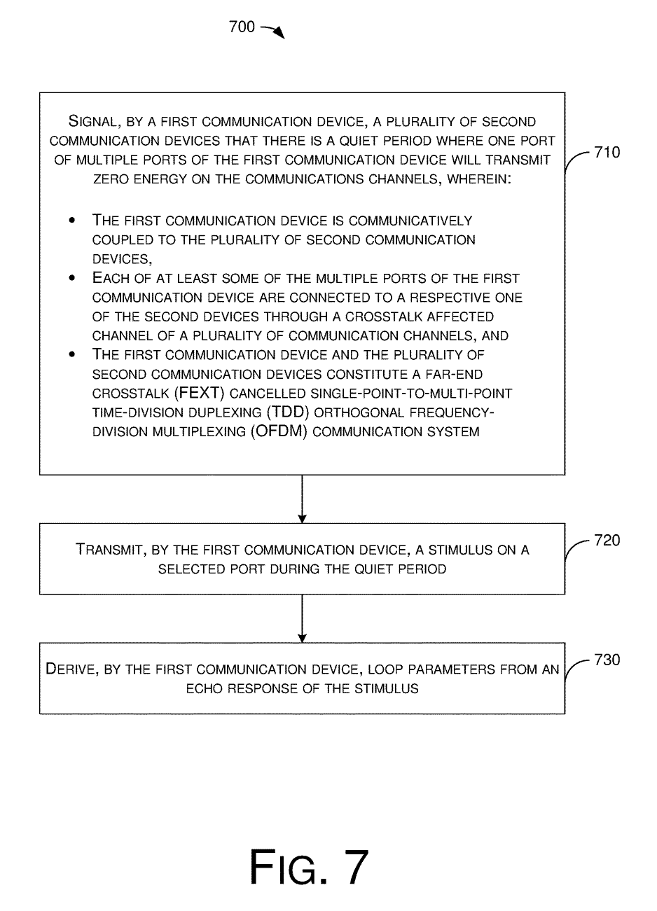

FIG. 7 illustrates an example process 700 in accordance with an implementation of the present disclosure. Process 700 may represent an aspect of implementing the proposed concepts and schemes such as those described with respect to some or all of FIG. 1-FIG. 5. More specifically, process 700 may represent an aspect of the proposed concepts and schemes pertaining to management of crosstalk in OFDM-based communication systems, such as prevention of crosstalk during SELT. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Process 700 may be implemented by or in apparatus 600 as well as any variations thereof. For instance, process 700 may be implemented by or in apparatus 600. Solely for illustrative purposes and without limiting the scope, process 700 is described below in the context of apparatus 600. Process 700 may begin at block 710.

At 710, process 700 may involve processor 610 of apparatus 600, functioning as a first communication device signaling a plurality of second communication devices (e.g., FTU-R1 and FTU-R2 as shown in FIG. 1 and FIG. 3) that there is a quiet period where one port of multiple communication ports of the first communication device will transmit zero energy on a plurality of communications channels between the first communication device and the second communication devices. The first communication device may be communicatively coupled to the plurality of second communication devices, with each of at least some of the multiple communication ports of the first communication device connected to a respective one of the second devices through a crosstalk affected channel of the plurality of communication channels. The first communication device (e.g., apparatus 600) and the second communication devices may constitute a far-end crosstalk (FEXT) cancelled single-point-to-multi-point time-division duplexing (TDD) orthogonal frequency-division multiplexing (OFDM) communication system. Process 700 may proceed from 710 to 720.

At 720, process 700 may involve processor 610 transmitting, via communication circuit 620, a stimulus on a selected port of the multiple communication ports during the quiet period. Process 700 may proceed from 720 to 730.

At 730, process 700 may involve processor 610 deriving loop parameters from an echo response of the stimulus.

In some embodiments, the loop parameters may include a loop length, wire gauges, a termination indication, a number of bridge taps, a location of bridge taps, a signal-to-noise ratio (SNR), and a channel capacity.

In some embodiments, the communication system may include a ITU-T G.9701 system

In some embodiments, the quiet period may be located in a SYNC symbol position. Alternatively, the quiet period may be located in a discontinuous operation interval (DOI).

### ADDITIONAL NOTES

Embodiments of the present disclosure are not limited to those described herein. The actual design and implementation of the proposed techniques, methods, devices and systems in accordance with the present disclosure may vary from the embodiments described herein. Those ordinarily skilled in the art may make various deviations and improvements based on the disclosed embodiments, and such deviations and improvements are still within the scope of the present disclosure. Accordingly, the scope of protection of a patent issued from the present disclosure is determined by the claims below.

What is claimed is:

1. A method implementable in a far-end crosstalk (FEXT) cancelled single-point-to-multi-point time-division duplexing (TDD) orthogonal frequency-division multiplexing (OFDM) communication system, comprising:
signaling, by a first communication device, a plurality of second communication devices that there is a quiet period where one port of a plurality of communication ports of the first communication device will transmit zero energy on a plurality of communications channels between the first communication device and the second communication devices;
transmitting, by the first communication device, a stimulus on a selected port of the plurality of communication ports during the quiet period; and
deriving, by the first communication device, loop parameters from an echo response of the stimulus,
wherein:
the first communication device is communicatively coupled to the plurality of second communication devices, and
each of at least some of the plurality of communication ports of the first communication device are connected to a respective one of the second devices through a crosstalk affected channel of the plurality of communication channels.

2. The method of claim 1, wherein the loop parameters comprise a loop length, wire gauges, a termination indication, a number of bridge taps, a location of bridge taps, a signal-to-noise ratio (SNR), and a channel capacity.

3. The method of claim 1, wherein the communication system comprises a ITU-T G.9701 system

4. The method of claim 1, wherein the quiet period is located in a SYNC symbol position.

5. The method of claim 1, wherein the quiet period is located in a discontinuous operation interval (DOI).

6. An apparatus, comprising:
a plurality of communication ports;
a communication circuit coupled to the plurality of communication ports; and
a processor coupled to control the communication circuit to transmit and receive signals through the plurality of communication ports, the processor capable of performing operations comprising:
signaling, via the communication circuit and through at least some of the plurality of communication ports, a plurality of second communication devices that there is a quiet period where one port of the plurality of communication ports will transmit zero energy on a plurality of communications channels between the communication circuit and the second communication devices;
transmitting, via the communication circuit, a stimulus on a selected port of the plurality of communication ports during the quiet period; and
deriving, via the communication circuit, loop parameters from an echo response of the stimulus,
wherein:
the at least some of the plurality of communication ports are communicatively coupled to the plurality of second communication devices,
each of at least some of the plurality of communication ports is connected to a respective one of the second devices through a crosstalk affected channel of the plurality of communication channels, and
the plurality of second communication devices are part of a far-end crosstalk (FEXT) cancelled single-point-to-multi-point time-division duplexing (TDD) orthogonal frequency-division multiplexing (OFDM) communication system.

7. The apparatus of claim 6, wherein the loop parameters comprise a loop length, wire gauges, a termination indication, a number of bridge taps, a location of bridge taps, a signal-to-noise ratio (SNR), and a channel capacity.

8. The apparatus of claim 6, wherein the communication system comprises a ITU-T G.9701 system

9. The apparatus of claim 6, wherein the quiet period is located in a SYNC symbol position.

10. The apparatus of claim 6, wherein the quiet period is located in a discontinuous operation interval (DOI).
